(19) United States
(12) Patent Application Publication
(10) Pub. No.: US 2024/0182152 A1
(43) Pub. Date: Jun. 6, 2024

(54) NOISE REDUCING NOSECONE FOR AIRCRAFT

(71) Applicant: ZIPLINE INTERNATIONAL INC., South San Francisco, CA (US)

(72) Inventors: Brendan Doyle Wade, San Francisco, CA (US); Philip M. Green, San Francisco, CA (US)

(21) Appl. No.: 18/285,402

(22) PCT Filed: Apr. 28, 2022
(86) PCT No.: PCT/US2022/026685

§ 371 Date: Oct. 3, 2023

Related U.S. Application Data
(60) Provisional application No. 63/182,636, filed on Apr. 30, 2021.

(51) Int. Cl. B64C 1/06; B64C 1/00; H04R 1/02; H04R 1/04; H04R 1/08; H04R 1/28

(52) U.S. Cl. CPC B64C 1/0683; H04R 1/028; H04R 1/04; H04R 1/086; H04R 1/2876; B64C 2001/0054; B64C 2220/00; H04R 2410/07; H04R 2499/13

(57) ABSTRACT

A nosecone of an aircraft sensor probe may include a first portion defining a tip of the nosecone that is formed from a first material. The nosecone further includes a second portion aft of the first portion and formed from a second material. The second portion may define an internal volume. The second material may have a greater porosity than the first material. The nosecone may further include a third portion aft of the second portion. The third portion may be configured to arrange a microphone assembly relative to the internal volume. The nosecone may a component or subassembly or a sensor probe for the aircraft. For example, the sensor probe may include the nosecone and the microphone assembly. The nosecone may be configured to block the audio signals at the tip and reduce turbulent noise of the audio signals associated with non-parallel local flow angles of the airflow.

### CROSS-REFERENCE TO RELATED APPLICATIONS

The present application claims priority to U.S. Patent Application No. 63/182,636 filed Apr. 30, 2021 and entitled “Noise Reducing Nosecone for Aircraft,” the entirety of which is incorporated herein by reference for all purposes.

### FIELD

The described embodiments relate generally to aircraft, and more particularly, to sensor arrays for aircraft.

### BACKGROUND

Sensors may be incorporated with an aircraft to detect audio signals and/or other information associated with a surrounding environment of the aircraft. For example, microphones and/or other sensors configured to detect audio signals may be used to determine the presence of obstacles, including other aircraft or air-borne objects, in an environment of the aircraft using the integrated sensor(s). Acoustic noise from the operation of the aircraft, turbulent airflow, non-parallel flow angles, and the like can hinder the operation of the sensor, for example, by limiting the ability of the sensor to isolate and distinguish target audio signals of the surrounding environment from the noise. High humidity conditions, such as from rain or fog, may also increase acoustic noise and hinder the operation of conventional sensors. For example, air composition and properties often change in high humidity conditions, such as viscosity changes, that may amplify aerodynamic noise. A sensor exposed to the amplified aerodynamic noise may be limited or inoperable in high humidity operations. As such, there is a need for systems and techniques to facilitate acoustic noise reduction in sensors of an aircraft.

### SUMMARY

In one example, a nosecone of an aircraft sensor probe is disclosed. The nosecone includes a first portion defining a tip of the nosecone. The tip of the nosecone is formed from a first material. The nosecone further includes a second portion aft of the first portion. The second portion is formed from a second material and defines an internal volume. The second material has a greater porosity than the first material. The nosecone further includes a third portion aft of the second portion. The third portion is configured to arrange a microphone assembly relative to the internal volume.

In another example, a sensor probe for association with a portion of an aircraft the sensor probe is disclosed. The sensor probe includes a nosecone. The sensor probe further includes a microphone assembly within the nosecone. The microphone assembly includes a portion configured to receive audio signals associated with an airflow downstream from a tip of the nosecone. The nosecone is configured to block the audio signals at the tip and reduce turbulent noise of the audio signals associated with non-parallel local flow angles of the airflow.

In another example, a method is disclosed. The method includes receiving an airflow along a tip of a nosecone of a sensor probe. The method further includes allowing entry of an audio signal associated with an external environment into an internal volume of the nosecone aft from the tip. The method further includes shielding the internal volume from environmental contaminants such as moisture and/or dust of the external environment. The method further includes detecting the audio signal using a microphone assembly held relative to the internal volume.

### BRIEF DESCRIPTION OF THE DRAWINGS

FIG. 1 depicts an isometric view of an aircraft having one or more peripheral assemblies.

FIG. 2 depicts a sensor probe of the aircraft of FIG. 1 including a nosecone.

FIG. 3 depicts an exploded view of the nosecone of FIG. 2.

FIG. 4 depicts a cross-sectional view of the sensor probe of FIG. 2, taken along line 4-4 of FIG. 2.

FIG. 4a depicts detail 4a-4a of FIG. 4.

FIG. 5 depicts an exploded view of the sensor probe of FIG. 2 including a microphone assembly.

FIG. 6 depicts a flow diagram for detecting an audio signal using a sensor probe.

FIG. 7 depicts an isometric view of another example of a sensor probe and a release assembly.

FIG. 8A depicts an exploded view of the sensor probe and the release assembly of FIG. 7.

FIG. 8B depicts detailed, partial section view of a portion of the sensor probe of FIG. 7 taken along line 8B-8B of FIG. 7.

FIG. 9 depicts a detail view of a connecting feature of the release assembly of FIG. 8A.

FIG. 10 depicts a detail view of the nosecone of the sensor probe of FIG. 8A.

FIG. 11A depicts a side view of a portion of an aircraft and the release assembly of FIG. 10.

FIG. 11B depict a side view of the portion of the aircraft of FIG. 1 and the release assembly of FIG. 7 partially separated from the portion of the aircraft.

### DETAILED DESCRIPTION

The description that follows includes sample systems, methods, and apparatuses that embody various elements of the present disclosure. However, it should be understood that the described disclosure may be practiced in a variety of forms in addition to those described herein.

The following disclosure describes systems and techniques to facilitate the detection of acoustic signals from an aircraft. A sample aircraft may include an unmanned aerial vehicle (UAV), including fixed-wing, rotorcraft (e.g., helicopters, quadrotors), and so on. The systems and techniques described herein are also applicable to piloted aerial vehicles and/or other vehicles or moving objects more generally. The acoustic signals may be detected using a sensor probe or other peripheral or integrated assembly of the UAV. The sensor probe may be configured to detect the acoustic signals during operation of the aircraft. The aircraft may include a detection and avoidance system that uses the acoustic signals to determine information associated with an environment of the aircraft, and can distinguish between audio signals produced by intruders, such as other aircraft, and audio signals produced by the aircraft's own engines (or flight system), distinguish between audio signals produced by intruders and natural sources (e.g., wind or weather noise), and determine spatial information of signals (e.g., provide a location estimation of the intruder relative to the aircraft). One such detection and avoidance system is described in PCT Patent Application No. PCT/US2020/067464, entitled “ACOUSTIC BASED DETECTION AND AVOIDANCE FOR AIRCRAFT,” of which is incorporated by reference herein. However, operational conditions of the UAV may induce excess noise that limits the ability to computationally distinguish between desired audio signals and noise, for example, due to turbulent airflow, high humidity conditions (e.g., rain or fog), the impact of flow at non-parallel flow angles to the UAV, the operation of the UAV itself, and so on.

The sensor probes of the present disclosure may mitigate such hindrances by having a microphone assembly and/or other sensor integrated within a nosecone. The nosecone may be configured to receive airflow and reduce turbulent noise of audio signals associated with the airflow. The nosecone may be further configured to direct the audio signals to the microphone assembly integrated therewith while generally shielding the microphone assembly from the atmosphere of the nosecone and the aerodynamic noise, including shielding the microphone from high humidity conditions as well as the noise induced by moisture and related conditions In this way, the structure and design of the nosecone itself may reduce turbulent noise detected at the microphone assembly such that the detection and avoidance system can adequately distinguish between desired audio signals and noise, computationally.

To facilitate the foregoing, the nosecone may be a multi-component structure that houses a microphone assembly and/or other sensor therein. The nosecone may generally be configured to selectively allow intrusion, such as allowing entry of a desired audio signal into the nosecone, aft or downstream, of the tip. For example, the nosecone may allow intrusion of selective audio signals into a portion of the nosecone aft of the tip and that includes a generally acoustically transparent portion for select audio signals, such as a portion having pores or pathways for air flow therethrough as described in greater detail below. The acoustically transparent portion may be a symmetrically shaped about a nosecone axis, such as defining a substantially cylindrical portion of the nosecone. The nosecone may arrange the microphone assembly aft of the tip in order to receive the audio signals introduced via the generally acoustically transparent portion. In some cases, the nosecone may impede audio signals at the tip such that audio signal may more readily enter the nosecone aft of the tip. More generally, the tip may be formed of a material having a lesser porosity than the acoustically transparent middle section. In this regard, the combination of redirecting or blocking of audio signals at the tip, while selectively receiving audio signal aft of the tip at a generally symmetrically-shaped portion, may provide the microphone assembly with audio signals having reduced noise.

In one example, the nosecone may include a first portion that defines the nosecone tip. The nosecone tip may be formed from a material that has a greater resistance to air-flow intrusion or passage than the acoustically transparent portion aft or downstream of the tip. For example, the nosecone tip may include an air-impervious or air-resistant material; however, this is not required. Sample materials include, without limitation, certain plastics, including nylon and polycarbonate, that define a strip or block of material through which air and fluid generally cannot traverse. The first portion may be configured to redirect audio signals around the nosecone tip. As such, audio signals may be blocked from entry into the nosecone along an axial direction of the nosecone. Aft or downstream of the first portion, the nosecone may further include a second portion. The second portion may be coupled to the first portion and define a generally symmetrical portion of the nosecone. The second portion may be formed from a material that is substantially or fully acoustically transparent, which could be or include a porous material, such as a porous, hydrophobic plastic. The second portion may be configured to receive acoustic signals and define an acoustic pathway for selective acoustic signals into an interior of the nosecone. For example, and as described herein, the porous material may have a pore size, thickness, construction, spacing and/or other properties that cooperate to selectively attenuate signals in order to maintain the acoustic pathway into the nosecone for signals having a select frequency, such as a frequency of less than about 1200 Hz.

The second portion may define an internal volume of the microphone assembly and maintain the acoustic pathway into the internal volume. For example, the second portion may include a tubular wall of the porous material revolved about an axial direction of the nosecone to define the internal volume. In other cases, the second portion may include a block of porous material without a defined internal volume, such as where the porous material is sufficiently acoustically transparent. The internal volume may have an internal passage within the nosecone that is associated with a portion of the microphone assembly configured to receive and detect audio signals. In this regard, the second portion may be configured to selectively receive the audio signals into the internal volume and direct the audio signals toward the microphone assembly. The nosecone may further include a third portion that is aft or downstream of the second portion. The third portion may be configured to arrange or house the microphone assembly relative to the internal volume that is defined by the second portion. The third portion may be formed from a substantially solid material, such as being formed from the same material as that used to form the first portion. The third portion may also facilitate a mechanical connection or coupling of the nosecone to a mount, shaft, tube, or other structure of the sensor probe.

The first, second, and third portions of the nosecone may cooperate to define a continuous, aerodynamic exterior surface of the nosecone. Apart from the pores of the porous section portion, which may have a size of around 50 microns (depending on the desired acoustic frequencies to be detected and thickness of the acoustically transparent portion), the exterior surface of the nosecone may be substantially free from slits, openings, passages or the like. The absence of large openings, e.g., those larger than the size of pores, allows the nosecone to have an enhanced performance in rain, fog, and other high-moisture environments. For example, rain, fog and other humid conditions can operate to saturate a material and/or generally amplify aerodynamic noise, for example, due to the change in viscosity and other properties of the air with the increase in moisture. The nosecone of the present disclosure may mitigate the aerodynamic noise from these and other conditions, in part, by impeding or preventing the saturation of the nosecone. For example, the nosecone may be formed from the hydrophobic material that has a sufficiently small pore size (e.g., between 10 and 100 microns, such as around 50 microns) that may impede or prevent moisture intrusion and saturation of the second portion. The pore size may yet be large enough to allow the passage of the select audio signals therethrough. As such, the second portion may maintain the acoustic pathway without the substantial presence of moisture along the acoustic pathway that would otherwise impair or increase the noise of the acoustic signal.

The first, second, and third portions of the nosecone may also cooperate to enhance the structural strength or rigidity of the nosecone such that the nosecone may withstand aerodynamic forces during operation of the UAV. For example, the nosecone may be a component of a sensor probe that extends elongated from a body of the UAV. The sensor probe may include an elongated member, such as a tube or other support structure that extends from a wing of UAV. The nosecone may be connected at an end of the elongated member opposite the wing. The porous second portion may generally be a softer and more flexible material. The first and third portions may include a more rigid material than the second portion and thus operate to enhance the structural rigidity of the nosecone. For example, the nosecone may be constructed with the second portion adhered or otherwise connected between the first and third portions. The first and third portions of the nosecone may account for the more flexible second portion by defining a more rigid tip and sensor mount section on opposing sides of the second portion. The more rigid tip may help the nosecone withstand impact in the event of a collision. In some cases, the first and/or third portions may include mounting structures, such as one or more prongs, that extend into a thickness of the second portion. The one or more prongs or other mounting structures may increase the rigidity of the second portion while also strengthening the mechanical connection between respective ones of the first and third portions and the second portion. In other cases, other mounting structures may be used, including flanges, clips, fasteners, and the like which may cooperate to structurally secure the first, second, and third portions to one another.

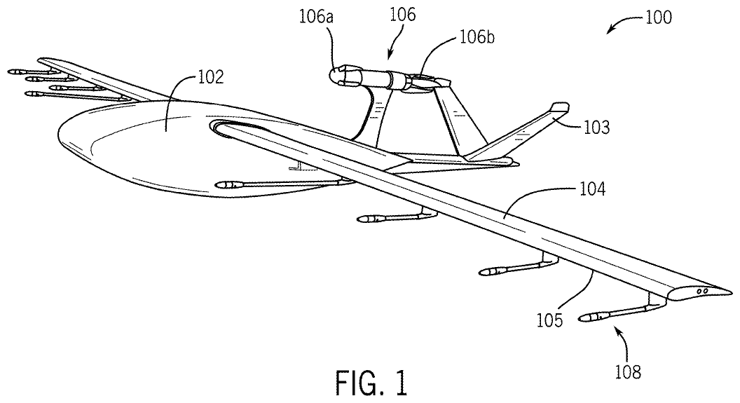

Turning now to the figures, FIG. 1A depicts an isometric view of an aircraft 100. The aircraft is shown as one example UAV that may include a nosecone of the present disclosure. The aircraft 100 is shown as a fixed-wing UAV. The aircraft 100 may include a fuselage 102, a tail 103, a wing assembly 104, and a propulsion system 106. The propulsion system 106 includes a front propeller 106a and a rear propeller 106b. It will be appreciated that the aircraft 100 may include other components and/or encompass other variations of aerial and more generally moving vehicles, including piloted aircraft and/or other types of UAVs, such as helicopter-type UAVs.

The aircraft 100 may be equipped with an arrangement of peripheral assemblies, such as a sensor probe 108. In the FIG. 1 example, an array of eight sensor probes are shown. However, it should be noted that the number and arrangement of probes may be varied as needed, e.g., depending on the sensitivity of the detection and avoidance software, size and type of the UAV, sensitivity of the probes, and the like. The sensor probe 108, or any other sensor probe, may be connected to a portion of the aircraft 100. In the example of FIG. 1, the sensor probe 108 is connected to an underside 105 of the wing assembly 104. The sensor probe 108 can be passively and/or actively manipulated in order to face toward an airflow when in use. In other cases, one or more sensor probes may be held substantially within the aircraft 100 itself rather than define an elongated structure.

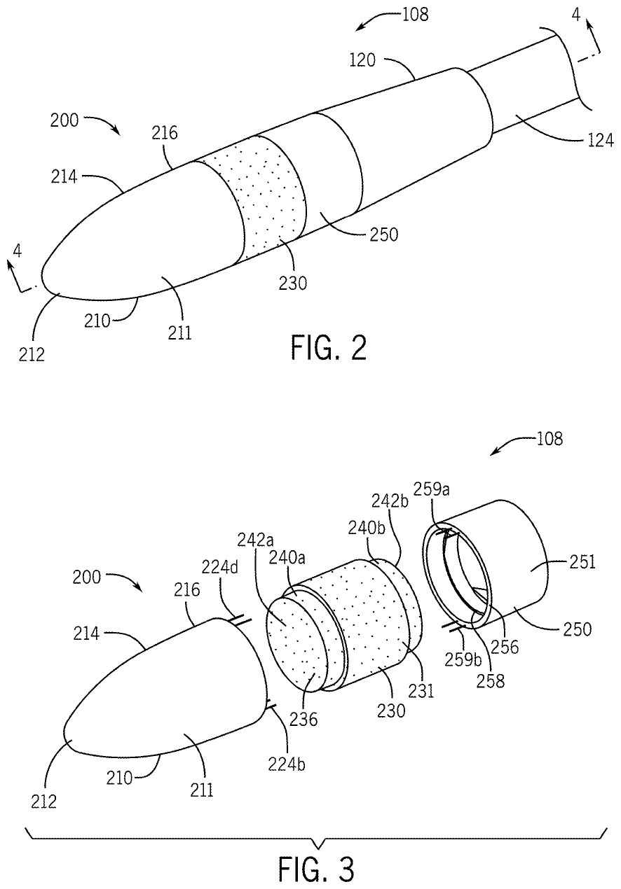

Turning to FIGS. 2 and 3, a nosecone 200 of the sensor probe 108 is shown. The nosecone 200 may be arranged at an end of the sensor probe 108. The nosecone 200 may receive airflow, including turbulent and non-parallel airflow, during operation of the aircraft 100. The nosecone 200 may have a multiple-component construction and include a first portion 210, a second portion 230 aft or downstream of the first portion 210, and a third portion 250 aft or downstream of the second portion 230. The first, second, third portions 210, 230, 250 may cooperate to define a continuous, aerodynamic contour of the nosecone 200 at the end of the sensor probe 108.

The first portion 210 may generally define a tip or terminal end of the nosecone 200. The first portion 210 may be the initial component or surface of contact for airflow as airflow is received by the nosecone 200. In the example of FIGS. 2 and 3, the first portion 210 includes a tip portion 212, a transition portion 214, and a body portion 216. The tip portion 212, the transition portion 214 and the body portion 216 may each be portions of, and cooperate to define, a surface 211 of the first portion 210. The surface 211 may generally be a surface that is resistant to the propagation of airflow therethrough, such as being a substantially air-impervious surface. The first portion 210 may be formed from a substantially air-impervious material. Without limitation, certain substantially plastics, including nylon and polycarbonate, may be used to form some or all of the first portion, where the plastics may have a sealed outer surface, i.e., not have holes or the like defined thereon. The material may generally block or redirect airflow from traversing a thickness of the first portion 210. As shown in FIGS. 2 and 3, the first portion 210 may be formed as a generally integrally formed or one-piece structure and thus the tip portion 212, the transition portion 214, and the body portion 216 may each be formed from the same piece of substantially solid material. The first portion 210 may also be adapted to have a certain rigidity that allows the nosecone 200 to withstand impact in the event of a collision.

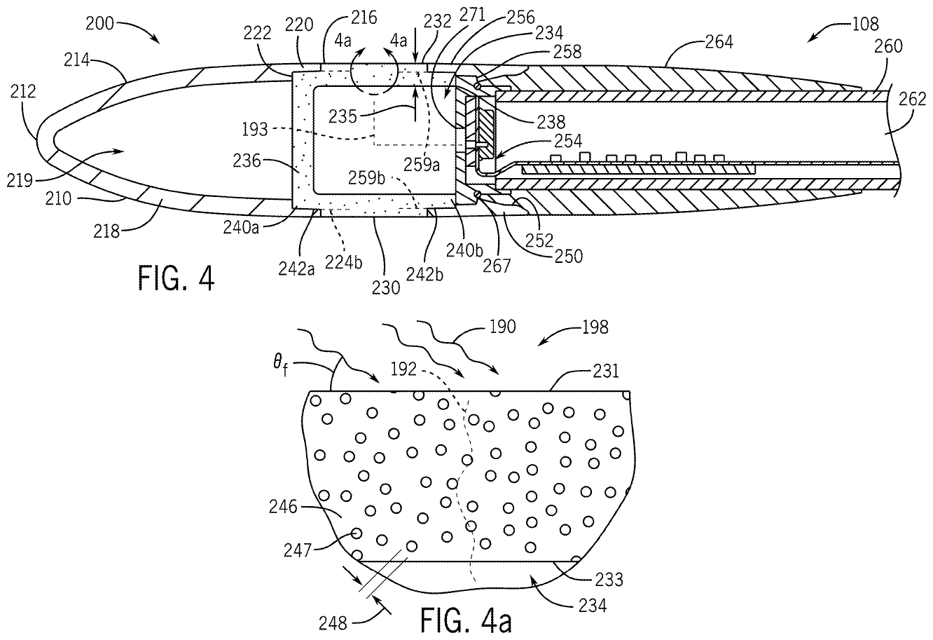

With reference to the cross-sectional view of FIG. 4, the first portion 210 may be a generally hollow structure with a wall portion 218 that defines a first portion cavity 219. The wall portion 218 may define the surface 211 extending along the tip portion 212, the transition portion 214, and the body portion 216. The wall portion 218 may define the first portion cavity 219 in order to reduce the weight of the first portion 210 while providing structural rigidity and maintaining a shape of the surface 211. In other cases, some or all of the first portion cavity 219 may be reduced, including cases in which the first portion cavity 219 is eliminated, such as where the first portion 210 is formed substantially entirely from a solid core of material.

The first portion 210 may also include one or more structures that facilitate attachment to other components of the nosecone 200. For example, and as shown in FIGS. 3 and 4, the first portion 210 may include an interface 220 opposite the tip portion 212. The interface 220 or engagement surface may include a mounting surface or shelf 222. The shelf 222 may be a stepped surface relative to a thickness of the wall portion 218. In some cases, the first portion 210 may include one or more mounting structures, such as prongs 224a, 224b. The prongs 224a, 224b may be spikes, spears, tabs, or other features that extend from the interface 220. The prongs 224a, 224b may have substantially sharp ends that are adapted to pierce or puncture softer material. The prongs 224a, 224b may be formed from the same, generally air-impervious material as the tip portion 212, transition portion 214 and/or the body portion 216.

The second portion 230, as shown in FIGS. 2-4A, may be formed from a material different from a material that forms the first portion 210. For example, the second portion 230 may be formed from a generally porous, hydrophobic material. Without limitation, a sintered material may be used to form the second portion 230, such as a porous sintered material. Sintering may allow for the fusion or connection of material using controlled heat and pressure, at a point below where the material liquefies. In this way, a void volume or pores may be maintained throughout the material during the fusion and formation of the material into a defined shape. Example sintered materials include a sintered polyethylene material or a sintered polypropylene material. In some cases, the sintered polyethylene material can be an ultrahigh molecular weight polyethylene material. Porex® manufactured by the Porex Corporation of Atlanta, Georgia may also be used. In this regard, the second portion 230 may include a porous surface 231. The porous surface 231 may be a portion of the porous material that defines an outer or exterior surface of the second portion 230. As described further below, the porous surface 231 may define an entry pathway for select acoustic signals into the nosecone 200.

The second portion 230 may be constructed with a wall 232 formed from a generally acoustically transparent material, such as the various porous materials and the like described herein. The wall 232 may be a section of the porous material that is revolved about an axial direction of the nosecone 200. In this regard, the wall 232 may be a tubular wall; however, this is not required. The wall 232 may be revolved about the axial direction of the nosecone 200 in order to define the porous surface 231 as a generally symmetrical exterior surface of the nosecone 200. The wall 232 may also define an internal volume 234 of the nosecone 200. The internal volume 234 may generally be a cylindrical internal volume of the nosecone 200 that is defined by an internal surface 233 of the wall 232 opposite the porous surface 231.

As shown in the detail view of FIG. 4a, a porous material 246, such as any of the porous materials described herein, may have a thickness 235 that extends between the porous surface 231 and the internal surface 233. The thickness 235 may be configured to maintain an acoustic pathway between the porous surface 231 and the internal surface 233 for select frequencies of acoustic signals. The acoustic pathway may be defined as a path through the porous material 246 along which an audio signal travels. In this regard, the acoustic pathway may be defined by the various pores of the porous material, which may permit the propagation of the audio signal through the porous material 246. As described further below, the acoustic pathway may continue into the internal or void volume of the nosecone 200 and toward an internal microphone assembly. With respect to the porous material 246, the material may be tuned base on factors, including the thickness and pore size, in order to maintain the acoustic pathway therethrough for signals having a frequency of less than about 1500 Hz, of less than about 1200 Hz, of less than about 100 Hz, including maintaining an acoustic pathway for signals having a frequency of between about 100 Hz to 700 Hz. In this regard, the thickness 235 may be about 3 mm or less, about 2 mm or less, about 1 mm less, including examples in which the thickness is being preferably about 1.6 mm or less.

The porous material 246 is also shown as having pores 247. The pores 247 may be arranged in any appropriate configuration throughout the porous material 246, such as being substantially evenly spaced, irregularly or randomly spaced, having zones of various pore concentration, and so on. The pores 247 may generally be configured to prevent the impact of direct airflow into the internal volume 234. In this manner, the second portion 230 may be configured to reduce broadband noise variations, and the pores 247 can help stabilize flow before it reaches internal components of the nosecone 200, such as a microphone assembly coupled therein. For example, flow along an exterior of the nosecone 200 may be turbulent and/or directed along non-parallel flow angles. The pores 247 may operate to reduce the turbulence and alter the directionality of the flow. The pores 247 may also be configured to limit the intrusion of environmental contaminants such as dust, debris, moisture, and other contaminants into the internal volume 234. The pores 247 may be configured to limit the intrusion of dust, debris, moisture and other contaminants into the internal volume 234 without limiting or blocking select, desired acoustic signals into the internal volume 234. For example, the pores 247 may have a pore size 248. In this regard, the pore size 248 may be about 100 microns or less, about 75 microns or less, preferably about 50 microns or less. While FIG. 4a shows the pores 247 generally having a common size, this is for purposes of illustration; in other cases, the size of pores may vary, with an average size of the pores generally corresponding to the pore size 248. The pores 247 may prevent the intrusion of dust and debris based on the pore size 248. For example, the pore size 248 may be smaller than typical dust size. Further, the pores 247 may generally have a winding or non-linear path into the internal volume 234 that operates to limit the ability of moisture and debris to enter the internal volume 234 and/or reach any internal microphone assembly held therein.

The porous material 246 and pores 247 may be further configured to enhance performance of the nosecone 200 in high humidity environments, including those in which rain and/or fog are present. For example, high-moisture content in the atmosphere often amplifies aerodynamic noise, in part, due to the increase viscosity of the air. Conventional nosecone designs may expose a sensor to the high-humidity atmosphere and thus subject the sensor to amplified noise. Additionally or alternatively, conventional nosecone designs may use materials that are subject to saturation, which may further degrade performance of an associated sensor. In contrast, the porous material 246 is generally a hydrophobic material that is configured to repel water and thus forestall or prevent saturation of the nosecone 200. Further, pores 247 of the porous material 246 may generally be sufficiently small to impede water migration through the nosecone 200. As described above, the porous material 246 may still allow the propagation of acoustic signals therethrough to provide acoustic transparency to the sensors shielded by the nosecone 200. In this manner, the internal sensor may be configured to detect the presence of audio signals in the environment of the nosecone without the amplified noise effects of moisture in the environment.

As shown in FIG. 4, the wall 232 may be formed substantially entirely from the porous material 246. In some cases, select sections of the wall 232 may be formed from the porous material 246, while other sections of the wall 232 or second portion 230 more generally may be formed from another material, such as the various plastic materials described herein. The wall 232 may be revolved about the axis of the nosecone 200 and define a passage 238. The passage 238 may be an internal opening of the second portion 230. The passage 238 may extend from the internal volume 234 and fluidically or acoustically couple the internal volume 234 to another, downstream portion of the nosecone 200, such as one or more of the microphone assemblies described herein. In this regard, the passage 238 may be configured to channel or route or direct the acoustic signal of the internal volume 234 to the downstream component of the nosecone 200.

The second portion 230 may further include an axial wall 236, as shown with reference to FIGS. 3 and 4. The axial wall 236 may be positioned opposite the passage 238. The axial wall 236 may be a generally circular section of the section portion that encloses one side of the internal volume 234. The axial wall 236 may be formed from the porous material 246. In other cases, the axial wall 236 may be formed from a solid or air-impervious material. The axial wall 236 may be configured to route the acoustic signal from the internal volume 234 to the opposing passage 238, for example, by defining a barrier opposite the passage 238. The axial wall 236 may also contribute to dampening characteristics of the signal in the internal volume 234.

The second portion 230 may further include a first interface 240a and a second interface 240b opposite the first interface 240a. The first interface 240a may be configured to define an engagement surface between the second portion 230 and another component forward or upstream of the second portion 230, such as the first portion 210. To facilitate the foregoing, the first interface 240a may include a first complimentary shelf 242a. The first complimentary shelf 242a may be a recessed or lowered edge portion of the porous surface 231. Similarly, the second interface 240b may be configured to define an engagement surface between the second portion 230 and another component aft or downstream of the second portion 230, such as the third portion 250. To facilitate the foregoing, the second interface 240b may include a second complimentary shelf 242b. The second complimentary shelf 242b may be a recessed or lowered edge portion of the porous surface 231 opposite the first complimentary shelf 242a.

With reference to FIGS. 2-4, the nosecone 200 also includes the third portion 250. The third portion 250 may be an anchoring portion of the nosecone 200. For example, the third portion 250 may facilitate attachment of the nosecone 200 to the aircraft 100, such as at the wing assembly 104. Additionally or alternatively, the third portion 250 may facilitate attachment of the nosecone 200 to a structural element of the sensor probe 108, such as attachment to a tube or other mounting structure that extends from the aircraft. The third portion 250 may be formed from a substantially solid or air-impervious material. For example, the third portion 250 may be formed from the same material as the first portion 210, as described above. In other cases, the third portion 250 may be formed from other substantially solid plastics and resins, and the like. In yet other cases and as described below, the third portion 250 and the first portion 210 may be portions of the same, single piece of material.

The third portion 250 is shown in FIG. 3 as defining an outer surface 251. The surface 251 may be a generally air-impervious surface. The surface 251 may define a substantially cylindrical portion of the nosecone 200. The surface 251 may be defined by a third portion wall 252. The third portion wall 252 may be revolved about the axial direction of the nosecone 200 and define a cavity 254 therein. The cavity 254 may be configured to arrange a microphone assembly relative to the internal volume 234 of the second portion 230, as described herein.

The third portion 250 may define various features that facilitate the connection of the third portion 250 to other components of the nosecone 200. For example, and as shown in FIGS. 3 and 4, the third portion 250 may include an interface 256. The interface 256 may be configured to define an engagement surface between the third portion 250 and another component forward or upstream of the third portion 250, such as the second portion 230. To facilitate the foregoing, the interface 256 may include a shelf 258. The shelf 258 may be a lip or edge portion of the wall 252. In some cases, the third portion 250 may include one or more mounting structures, such as prongs 259a, 259b. The prongs 259a, 259b may be substantially analogous to the prongs 224a, 224b described above with respect to the first portion 210. In some cases, the prongs 224a, 224b and the prongs 259a, 259b may be portions of the same, continuous structure. For example, a given prong may extend continuously or uninterrupted between the first portion 210 and the third portion 250, and through a complete length of the second portion 230.

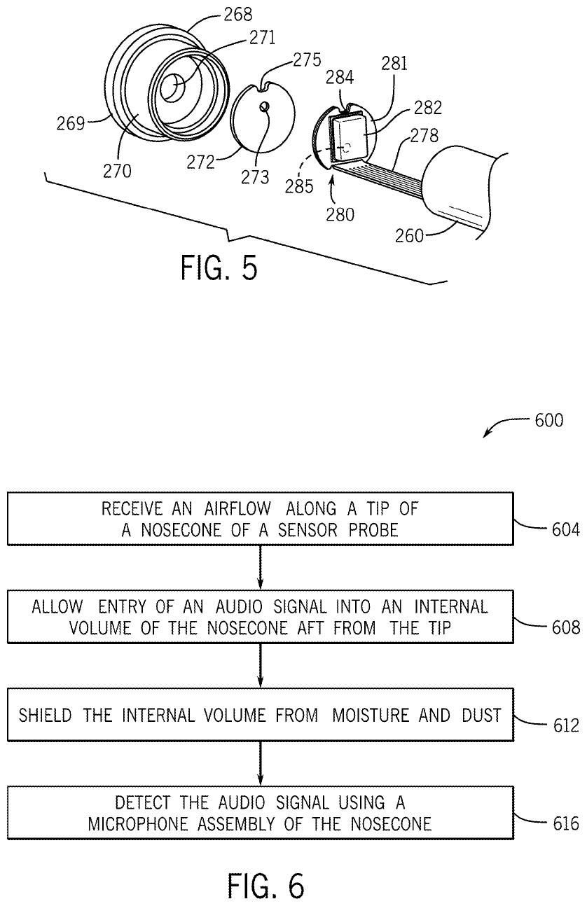

The nosecone 200 may be an assembly or subassembly of the sensor 108, as described herein. In addition to the nosecone 200, the sensor 108 may include a microphone assembly 280 and various other components that facilitate attachment of the microphone assembly 280 to the nosecone 200. For example, and with reference to FIGS. 4 and 5, the sensor probe 108 is shown as including the microphone assembly 280. The microphone assembly 280 may include a structural component 281 and a microphone 282. The structural component 281 may generally be a backing board configured to arrange the microphone 282 at a desired location within the sensor probe 108. In one example, the structural component 281 may be a circular component that defines an alignment tab 284 or notch or other alignment-type feature at a selected portion. The structural component 281 may also include a hole, opening or other portion acoustically transparent to the microphone 282. For example, the microphone 282 may having a portion 285 configured to receive audio signals for the microphone assembly 280. The portion 285 may be integrated with or adjacent the backing board 181 in a manner that allows audio signals to be received by the microphone 282. In some cases, the portion 285 may be an opening to a microphone of the microphone device 182. The portion 185 may be arranged in any appropriate direction, including in some cases, being arranged to face a direction substantially transverse to an axial direction of the nosecone 200. By arranging the portion 185 substantially transverse to an axial direction of the nosecone 200, the microphone assembly 280 may accommodate larger sizes of the microphone 282. For example, with the portion 185 arranged substantially traverse to the axial direction, a body of the microphone 282 may be arranged correspondingly within the nosecone 200 to assume a larger footprint therein. In this manner, the microphone 282 may have a larger height, width, length or other dimension, which may allow the microphone 282 to include larger or more power-intensive, or more sensitive components housed therein, as appropriate for a given application.

The sensor probe 108 may also include a flex harness 278 and a tube 260, as shown in FIG. 5. The flex harness 278 may include a collection of electrical connectors of the sensor probe 108. For example, the flex harness 278 may operate to connect the microphone assembly 280 to systems and controls of the aircraft 100. The tube 260 may receive a portion of the flex harness 278 in a tube volume 262 and be used to carry the flex harness 278 to the systems and controls of the aircraft. More generally, the tube 260 may include any elongated member that extends from a body of the aircraft 100 in order to arrange and position the sensor probe 108 extending away from a body of the aircraft 100, wing or other structure.

With reference to FIG. 5, the sensor probe 108 is shown as further including a microphone assembly mount 268 and an adhesive 272. The microphone assembly mount 268 may be a generally tubular structure that defines a flange portion 269, an interfacing sleeve 270, port 271. The flange portion 269 may include a lip or other feature that is configured to be received within the nosecone 200. The interfacing sleeve 270 may be configured to define a mount or a seat for the microphone assembly 280, such as by defining a pocket for receiving the microphone assembly 280 therein. The port 271 may extend completely through the microphone assembly mount 268 and be alignable with the portion 285, thereby allowing an acoustic signal to pass through the microphone assembly mount 268 for detection by the microphone assembly 280. The optional adhesive 272 may be a double-sided adhesive and fit into the pocket of the interfacing sleeve 270. The adhesive 272 may define a hole 273 extending therethrough for propagation of acoustic signals. The adhesive 272 may further define a notch 275 for alignment of the adhesive within the pocket and/or with the alignment tab 284.

With reference to FIG. 4, the sensor probe 108 is shown as further including a nosecone mount 264. The nosecone mount 264 may be a generally tubular structure that is configured to define an interface between the nosecone 200 and the tube 260. For example, the nosecone mount may be configured to receive a portion of the nosecone 200 an define a mounting surface for the nosecone 200. Additionally or alternatively, the nosecone mount 264 may define a direct structural connection between the nosecone 200 and the aircraft 100, such as a defining a direct structural connection between the nosecone 200 and the wing assembly 104. The nosecone mount 264 may have an exterior contour that generally tapers or decreases between a maximum diameter of the nosecone 200 and the diameter of the tube 260. A sealing element, such as an O-ring 267 can define a moisture barrier between the nosecone mount 264 and the nosecone 200 in order to block moisture intrusion towards the microphone assembly 280 and other internal components of the sensor probe 108.

The nosecone 200 may be coupled such that the first portion 210 is coupled to the second portion 230. The nosecone 200 may be further coupled such that the second portion 230 is coupled to the third portion 250. In this regard, the first portion 210, the second portion 230, and the third portion 250 may be coupled to define a continuous exterior surface of the nosecone 200. For example, the surface 211 of the first portion 210, the porous surface 231 of the second portion 230, and the surface 251 of the third portion 250 may cooperate to define the continuous exterior surface of the nosecone 200. Absent the pores of the porous surface 231, the exterior surface of the nosecone 200 may be free of visible slits, openings, and or other features that would otherwise receive and hold moisture. While the differing materials of the second portion 230 and the respective first and third portions 210, 250 may define a seam therebetween, an exterior contour of the second portion 230 may be similar or the same as the contour of the first portion 210 and/or the third portion 250 at the seam. As such, the first, second, third portions 210, 230, 250 may define the continuous external surface of the nosecone 200 as a continuous aerodynamic surface of the nosecone 200 extending from the tip portion 212 to an opposing end of the nosecone 200. For example, the first, second, third portions 210, 230, 250 may be coextensive, with the middle, second portion 230 having pores and defining a section of the nosecone 200 having a different surface texture than the first and third portions 210, 250.

The first and second portions 210, 230 may be coupled with the second portion 230 engaged with the first portion 210. For example, the axial wall 236 may be fitted into the first portion cavity 219 such that the interface 220 of the first portion 210 and the first interface 240a may engage one another. For example, the first complimentary shelf 242a of the second portion 230 may be slid under and overlapped with the shelf 222 of the first portion 210. A friction or interference fit may be defined between the shelf 242a and the shelf 222. An adhesive may be applied between the shelf 242a and the shelf 222 in order to secure the first and second portions 210, 230 to one another. In some cases, the shelf 242a may be slid relative to the shelf 222 such that the prongs 224a, 224b of the first portion 210 are inserted into a thickness of the second portion 230. For example, the prongs 224a, 224b may pierce and extend into the thickness along some or all of an axial length of the second portion 230. The prongs 224a, 224b and/or other prongs may be circumferentially disposed about the first portion 210. As such, the prongs 224a, 224b may operate to rotationally constrain the second portion 230 relative to the first portion 210. The prongs 224a, 224b may also induce a wedging effect or otherwise also axially constrain the second portion 230 relative to the first portion 210.

The second and third portions 230, 250 may be coupled with the third portion 250 engaged with the second portion 230. For example, the third portion 250 may be at least partially fitted over the second portion such that the interface 240b of the second portion 230 and the interface 256 of the third portion 250 may engage one another. For example, the second complimentary shelf 242b of the second portion 230 may be slid under and overlapped with the shelf 258 of the third portion 250. A friction or interference fit may be defined between the shelf 242b and the shelf 258. An adhesive may be applied between the shelf 242b and the shelf 258 in order to secure the second and third portions 230, 250 to one another. In some cases, the shelf 242b may be slid relative to the shelf 228 such that the prongs 259a, 259b of the third portion 250 are inserted into a thickness of the second portion 230. For example, the prongs 259a, 259b may pierce and extend into the thickness along some or all of an axial length of the second portion 230. The prongs 259a, 259b and/or other prongs may be circumferentially disposed about the third portion 250. As such, the prongs 259a, 259b may operate to rotationally constrain the second portion 230 relative to the third portion 250. The prongs 259a, 259b may also induce a wedging effect or otherwise also axially constrain the second portion 230 relative to the third portion 250.

The microphone assembly 280 may be coupled with the nosecone 200 via the microphone assembly mount 268. For example, the microphone assembly 280 may be at least partially inserted into a pocket that is defined by the interfacing sleeve 270 of the microphone assembly mount 268. The microphone assembly 280 may be arranged such that the portion 285 is positioned to receive acoustic signals through the microphone assembly mount 268, such as receiving signals through the port 271. In some cases, the alignment tab 284 may be mated with a complimentary feature of the interfacing sleeve 270 in order to define a circumferential position of the microphone assembly 280 relative to the nosecone 200. The microphone assembly 280 may be secured in the microphone assembly mount via press-fit or interference fit. For example, the structural component 281 may partially deform and snap into the interfacing sleeve 270. Additionally or alternatively, the adhesive 272 may be used to adhere the microphone assembly 280 to the microphone assembly mount 268. Where the adhesive 272 is used, the hole 273 or other feature of the adhesive 272 may be arranged in order to allow the propagation of acoustic signals to the portion 285 with minimal or no interference or obstruction from the adhesive 272.

The microphone assembly mount 268 may be coupled with the sensor probe 108 at the third portion 250 and the nosecone mount 264. For example, and as shown in FIG. 4, the microphone assembly mount 268 may be at least partially received by and seated in the third portion 250. The microphone assembly mount 268 may be at partially received by the cavity 254 of the third portion 250 such that the port 271 faces and is positioned generally adjacent to the internal volume 234 of the second portion 230. In this regard, acoustic signals may travel along the acoustic pathway and propagate from the internal volume 234 to the port 271. To facilitate the foregoing, the flange portion 269 of the microphone assembly mount 268 may be engaged with the second portion 230 and the third portion 250. For example, and as shown in FIG. 4, the microphone assembly mount 268 may be seated on the second portion 230 and generally covering or otherwise extending over the internal volume 234. The third portion 250 may be fitted over the flange portion 269 so that the third portion 250 surrounds the microphone assembly mount 268.

The microphone assembly mount 268 may be further coupled such that an outer portion of the interfacing sleeve 270 is engaged with the nosecone mount 264. For example, and as shown in FIG. 4, a portion of the nosecone mount 264 may be slid over the interfacing sleeve 270. An adhesive may be applied to secure the nosecone mount 264 to the interfacing sleeve 270. The portion of the nosecone mount 264 may be slid over the interfacing sleeve 270 and under a section of the third portion 250. In this manner, the portion of the interfacing sleeve 270 may define a wedge that extends between the third portion 250 and the interfacing sleeve 270. This arrangement may enhance the structural rigidity of the nosecone 200 by allowing both the third portion 250 and the interfacing sleeve 270 to attach to the nosecone mount 264. The O-ring 267 may be arranged at one or more interfaces or junctures of the third portion 250, the nosecone mount 264, and/or the microphone assembly mount 268 in order to mitigate moisture and debris ingress toward the microphone assembly 280.

In operation, the sensor probe 108 is configured to detect audio signals associated with an airflow received by the sensor probe 108. The nosecone 200 of the sensor probe 108 is configured to reduce turbulent noise of the audio signals. The nosecone 200 may reduce the turbulent noise to a level that allows a detection and avoidance system and/or other system to computationally distinguish between target signals, e.g., other aircraft, and noise or other extraneous signal detected at the microphone assembly 280. For example, the sensor probe 108 may be mounted to the aircraft 100 and is operable in flight to detect signals via the microphone assembly 180. The nosecone 200 includes various structural features and configurations, as described herein, that are configured to attenuate noise from reaching the microphone assembly 180. As such, less noise reaches the microphone assembly 180, which in turn allows the detection and avoidance system to more precisely distinguish between target signals and noise.

With reference to the flow diagram of FIG. 6, a process 600 is depicted for detecting an audio signal using the sensor probe 108 and reducing noise using the nosecone 200. At operation 604, an airflow is received along a nosecone of a sensor probe. For example, and with reference to FIGS. 4 and 4A, an airflow 190 may be received by the nosecone 200 of the sensor probe 108. The airflow 190 may be a generally non-parallel airflow to the nosecone 200, such as by having a direction offset from an axial direction of the nosecone 200 by an offset angle θ_{f}. The airflow 190 may also be a turbulent airflow with abrupt or irregular changes in pressure and velocity and/or other characteristics relative to the nosecone 200, and varying along a length of the nosecone 200.

The nosecone 200 may operate in or otherwise traverse an external environment 198. The airflow 190 may be airflow in the external environment 198. The airflow 190 may be associated with or carry an acoustic signal. The acoustic signal may include any of a variety of sounds, including, without limitation audio signals produced by intruders, such as other aircraft, and audio signals produced by the aircraft's own engines (or flight system), audio signals produced by intruders and natural sources (e.g., wind or weather noise), and so on.

The sensor probe 108 may be configured to detect the acoustic signals associated with the external environment 198 using the microphone assembly 280. The nosecone 200 may be configured to reduce the noise of the acoustic signals such that the acoustic signals of the external environment 198 that reach the microphone assembly 280 are attenuated or otherwise within a selected range that filters or removes noise of the signal that is otherwise present in the external environment. To facilitate the foregoing, at the operation 604, the airflow 190 may be generally blocked at the tip portion 212 of the nosecone 200. The tip portion 212 may be formed from the air-impervious material and prevent the propagation of acoustic signals into the internal volume 234 from the tip portion 212. With reference to operation 608 of FIG. 6, an audio signal is allowed entry into the internal volume 234 of the nosecone 200 aft from the tip portion 212. For example and with reference to FIGS. 4 and 4a, the nosecone 200 may allow entry of acoustic signals associated with the airflow 190 at the second portion 230 aft of the tip portion 212. The second portion 230 may be a generally symmetrical component about the axial direction of the nosecone 200 and thus the airflow 190 may have a reduced noise characteristics along this section of the nosecone 200.

As shown in FIG. 4a, the nosecone 200 may allow entry of an audio signal 192 into the internal volume 234. For example, the audio signal 192 may advance through the porous material 246 between the porous surface 231 and the internal surface 233. The pore size 274 and the thickness 235 may cooperate to attenuate the audio signal 192 in order to allow select frequencies into the internal volume 234. The select frequencies may be frequencies that do not include frequencies that are generally associated with noise, such as the noise from the operation of the aircraft 100. As described herein, the pore size 276 of around 50 microns and thickness 235 of around 1.6 mm may allow the second portion 230 to define an acoustic pathway therethrough for frequencies of the audio signal 192 that are less than around 1200 Hz. It will be appreciated that both the pore size and the thickness may be modified in order to change a range of the frequencies that are permitted into the internal volume 234.

The second portion 230 may maintain the acoustic pathway while also, with reference to operation 612 of FIG. 6, shielding the internal volume 234 from moisture and dust. In this regard, the second portion 230 may also operate to reduce interference that may otherwise be caused by moisture and/or water saturation of the nosecone 200. For example, the second portion 230 may be formed from a hydrophobic material and thus generally repel moisture away from the second portion 230. Further, the pore size may be tuned in order to prevent water saturation of the second portion 230. The combination of the hydrophobic material and pore size may generally operate to enhance the performance of the nosecone 200 in high moisture environments including rain and fog environments, by mitigating the aerodynamic noise impacts of moisture. As one example, a pore size of about 50 micron may prevent water from being held in the pores of the second portion 230. As such, the sensor probe 108 may operate in rain, fog, and/or other high-moisture environments without having the nosecone become saturated with water, which would otherwise detract from the operation of the microphone assembly 280.

With reference to operation 616, the audio signal 192 may be detected by the microphone assembly 280. For example, and with reference to FIG. 4, the audio signal 192 may propagate along an illustrative path 193 through the internal volume 234 and toward the microphone assembly 280. The path 193 may extend from the internal volume 234 through the port 271, the hole 273 and to the portion 285 of the microphone assembly 280. In some cases, the path 193 may include turns and the like in order to reach the portion 285, which as described above, may be arranged to face a direction substantially perpendicular to an axial direction of the nosecone 200 in order to accommodate larger microphones.

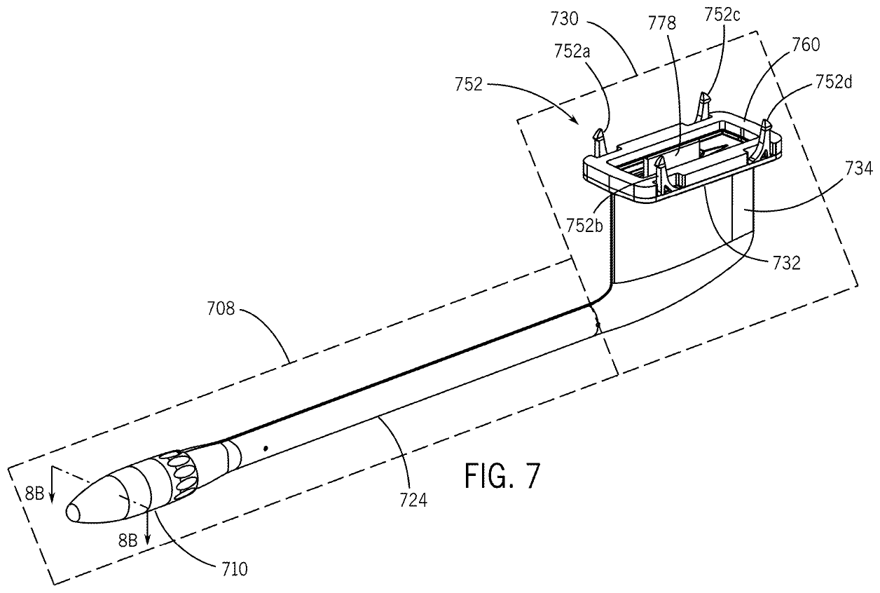

Additional breakaway or release mechanisms or assemblies and connecting features are contemplated herein. FIGS. 7-11B show an example of a connecting feature configured to release the sensor probe from a portion of an aircraft upon receipt of a threshold force. For example, the connecting feature may, in a first configuration, define a secure connection between the sensor probe and the portion of the aircraft such that the sensor probe remains connected to the aircraft during standard flight operations. In a second configuration, the connecting feature may bend or deform, upon receipt of a threshold force, such that the sensor probe is released from the aircraft. In some embodiments, the threshold force is a force experienced at a particular location and/or angle relative to the connection feature. For example, the connecting feature may be configured to release the sensor probe from the aircraft upon the threshold force being received at a particular angle relative to the sensor probe. In some embodiments, the threshold force may be received at an angle associated with a collision, such as an angle that is offset from a longitudinal direction of the sensor probe 708. Stated in another manner, the connecting feature may be configured to release the sensor probe from the aircraft for different values of a threshold force based, in part, on the direction of the threshold force. As an illustration, the connecting feature may be configured to release the sensor probe from the aircraft based on the threshold force having a first value when received along the longitudinal direction, and further, the connecting feature may be configured to release the sensor probe from the aircraft based on the threshold force having a second value, different from the first value, when received along another direction.

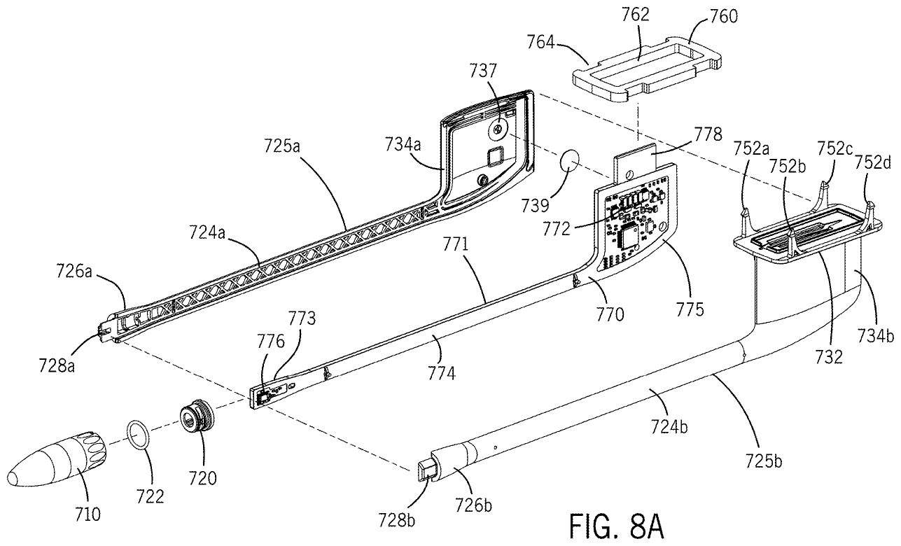

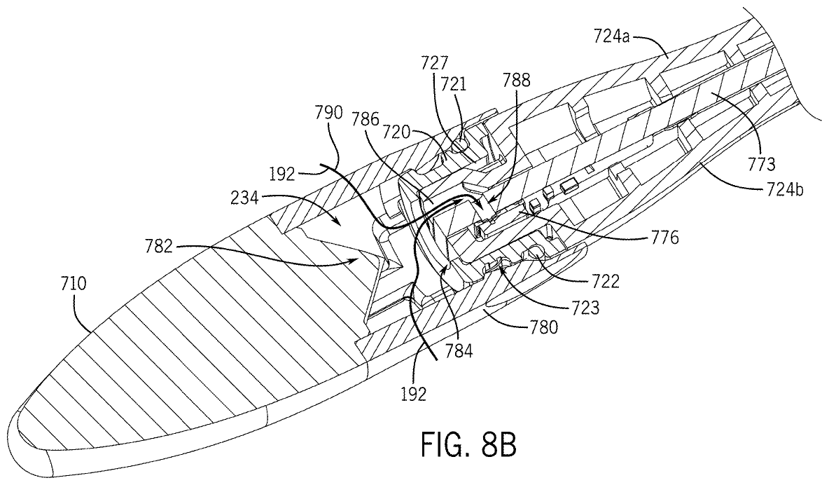

With reference to FIGS. 7 and 8A, a sensor probe 708 is shown. The sensor probe 708 may be substantially analogous to the sensor probe 108, as shown as described above in relation to FIGS. 2 and 3. The sensor probe 708

As further shown in FIGS. 7 and 8A, a release assembly 730 is provided. The release assembly 730 may be functionally similar to the breakaway mechanism 130 described above in relation to FIGS. 2 and 3. For example, the release assembly 730 may be configured to separate the sensor probe 708 (or peripheral assembly more broadly) from a portion of the aircraft, such as the wing. Further, the release assembly 730 may include a connecting feature 752. The connecting feature 752 may be configured to releasably connect the sensor probe 708 to the portion of the aircraft. In the embodiment of FIGS. 7-11B, the connecting feature 752 may be a flexible component that flexes or deforms upon the receipt of a predetermined threshold force in order to release the sensor probe 708 from the portion of the aircraft.

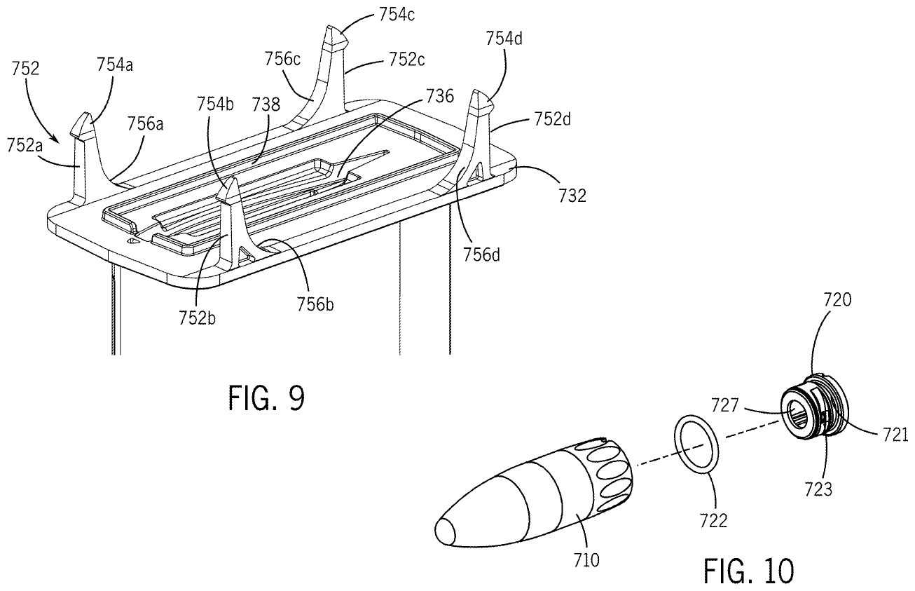

For example, and with reference to FIGS. 8A and 9, the connecting feature 752 may include at least one flexible prong. In the example of FIGS. 8A and 9, four flexible prongs are shown: a first flexible prong 752a, a second flexible prong 752b, a third flexible prong 752c, and a fourth flexible prong 752d. In other cases, more or fewer flexible prongs may be implemented. With reference to the first flexible prong 752a, the first flexible prong 752a may include an overhang portion 754a and a flexible portion 756a. The overhang portion 754a may include or define a free end of the first prong 752a receivable by a portion of the aircraft. The overhang portion 754a may be integrally connected with the flexible portion 756a and define an overhang or undercut therewith. For example, along at least one dimension, such as a width dimension, the flexible portion 756a may have a lesser value than the overhang portion 754a. This may allow the overhang portion 754a to be inserted into a catch or other feature of the portion of the aircraft and impede release of the first prong 752a therefrom. In some cases, the flexible portion 756a may have a reduced material thickness or content in order to permit flexing. In this regard, movement of the release assembly 730 may cause the flexible portion 756a to flex such that the overhang portion 756a moves, releasing the overhang portion 754a from the catch of the portion of the wing assembly upon the receipt of the predetermined force. It will be appreciated the second prong 752b may include an overhang portion 754b and a flexible portion 756b, the third prong 752c may include an overhang portion 754c and a flexible portion 756c, and the fourth prong 752d may include an overhang portion 754d and a flexible portion 756d; redundant explanation of which is omitted here for clarity.

The connection feature 752, including one or more of the flexible prongs 752a-752d, may be fixedly attached to the sensor probe 708 via the release assembly 730. In this regard, connection feature 752 may deform for release from the aircraft, permitting the release assembly 730 and the sensor probe 708 to separate from the aircraft as well. While many structures of the release assembly 730 are contemplated herein, FIGS. 8A and 9 show the release assembly 730 as including a blade portion 734 and a mounting plate portion 732. The blade portion 734 may be an aerodynamic component of that resembles the shape of a fin. The blade portion 734 may be configured to house electronic components and form a mechanical connection between the aircraft and the sensor probe 708, as described herein. The mounting plate portion 732 may be a structural component of the release assembly 730 that defines a support base for the connecting feature 752.

With reference to FIG. 9, the mounting portion plate 732 is shown rigidly connected to the blade portion 734 and generally arranged perpendicular therewith. The mounting portion plate 732 is shown in FIG. 9 as including an electronics passage 736 and a peripheral lip 738. The electronics passage 736 may be a through portion of the mounting plate 732 that extends into the blade portion 734, providing passage for electronic components and connections housed in the blade portion 734. The peripheral lip 738 may be a raised edge about the electronics passage 736. In some cases, the peripheral lip 738 may provide a barrier to external elements, including moisture and debris, from interacting with the electronic components. For example, the peripheral lip 738 may be configured to be seated on a complementary component of the aircraft and/or engaged with a dampener for substantially sealing the electronic components with the aircraft and reducing vibrations therewith. As further shown in FIG. 9, the flexible prongs 752a-752d are connected to, and extend from, the mounting plate portion 732. The respective flexible portions 756a-756d may protrude from the mounting plate portion 732 and allow the corresponding overhang portion 754a-754d to move or flex relative to the mounting plate portion 732. The prongs 752a-752d are arranged generally at corners of the mounting plate portion 732 in order to define a multi-point releasable connection between the sensor probe 708 and the portion of the aircraft. In other cases, other arrangement of prongs 752a-752d are contemplated herein.

The blade portion 734 may be constructed in a variety of manners, such as being an integrally formed component or a multi-piece assembly. In the example of FIGS. 7 and 8A, the blade portion 734 may include a first blade portion 734a and a second blade portion 734b. The first and second blade portions 734a, 734b may each be considered blade portions halves that are connected to one another to define the blade portion 734. The first and second blade portions 734a, 734b may cooperate to form a cavity or opening therebetween. The first blade portion 734a may define a vent hole 737 therethrough. A Gore™ vent or other barrier 739 may be arrangeable on the vent hole 737. The combination of the vent hole 737 and the barrier 739 may permit ingress and egress of air into the cavity defined by the first and second blade portions 734a, 734b (e.g., to facilitate pressure equalization), while blocking moisture and debris from entering. The second blade portion 734b may be rigidly connected to the mounting plate portion 734, as shown in FIG. 8A. The first and second blade portion 734a, 734b may be fixedly connected to the sensor probe 708, as described below.

For example, the sensor probe 708 may include an elongated tube 724 and a nosecone 710. The elongated tube 724 and the nosecone 710 may be substantially analogous to the elongated tube 124 and the nosecone 110 described above in relation to FIGS. 2 and 3. Notwithstanding the foregoing, the elongated tube 724 is shown in the example of FIG. 8A as include a first elongated tube portion 724a and the second elongated tube portion 724b The first and second elongated tube portion 724a, 724b may be considered elongated tube halves that are connected to one another to define the elongated portion 724. The first and second elongated tube portion 724a, 724b may cooperate to define a tube cavity therebetween for passage of electronic components to the nosecone 710.

The elongated tube 726 and the blade 734 may be fixedly connected to one another. In some cases, the elongated tube 726 and the blade 734 may be separate components that are bonded to one another. In other cases, the elongated tube 726 and the blade 734 (or portions thereof) may be constructed as an integrally formed structure. For example, and as shown in FIG. 8A, a first superstructure a first superstructure 725a is provided. The first superstructure 725a may be a single, integrally formed component that includes both the first blade portion 734a and the first elongated tube portion 724a. Further, a second superstructure 725b is provided. The second superstructure 725b may be a single, integrally formed component that includes both the second blade portion 734b and the second elongated tube portion 724b. In some cases, the second superstructure 725b may also include the mounting plate portion 732 and the connecting feature 752.

The elongated portion 724 is configured for coupling with the nosecone 710. As shown in FIGS. 8A and 10, the first superstructure 725a may include a first aerodynamic end 726a that terminates in a first seat 728a. Further, the second superstructure 725b may include a second aerodynamic end 726b that terminates in a second seat 728b. The first and second aerodynamic ends 726a, 726b may cooperate to transition an exterior dimension of the sensor probe 708 to the lesser width of the elongated portion 726 to the greater width of the nosecone 710. The first and second seats 728a, 728b may cooperate to define a mount or other feature to facilitate connection of the nosecone 710 to the elongate portion 726.

For example, the sensor probe 708 may include a nosecone mount 720 and a sealing ring 722. Broadly, the nosecone mount 720 may be seated on the first and second seats 728a, 728. In some cases, an adhesive, fastener, or other mechanism may be used to secure the nosecone mount 720 to the first and second seats 728a, 728b. With reference to FIG. 10, the nosecone mount 720 may include an annular rim 721, a locking groove 723, and a through portion 725. The annular rim 721 may be a circumferential groove or cut configured to receive a sealing element, such as the sealing element 722. The locking groove 723 may include threads, a stop, bayoneted mount, or other feature to facilitate retaining the nosecone 710 on the nosecone mount 720. In one example, the nosecone 710 may couple to the nosecone mount 720 via a binary mount structure, such that the nosecone 710 is either fully coupled to the mount 720 or is decoupled from the mount 720. A binary mount structure may have benefits over traditional thread mount structures in that the coupling of the nosecone 710 to the mount 720 is not subject to over or under tightening. In one example, the binary mount structure includes a quarter turn bayonetted mount. The through portion 725 may be a through portion 725 of the nosecone mount 720 that extends fully through a longitudinal thickness of the nosecone mount 720 for the passage of electronic components, including wires, therethrough. The nosecone 710 may be coupleable with the nosecone mount 720 via snap fit connection. For example, the sealing element 722 may be seated on the annular rim 721. Next, the nosecone 710 may be advanced onto the nosecone mount 220 and engaged with the locking groove 723. In some cases, the nosecone 710 may be coupled with the locking groove 723 such that a quarter turn of the nosecone 710 relative to the nosecone mount 720 allows the nosecone to be separated from the nosecone mount 720. The through portion 727 may be aligned with the nosecone 710 such that sensors, including microphones, may be used to detect sound at the nosecone 710, as described herein, and transmit the signal for processing to other electronic components of the sensor probe 708 or aircraft more generally.

In one example, the sensor probe 708 includes a printed circuit board assembly or PCBA component 770. The PCBA component 770 may include a structural board 771. The structural board 771 may be a generally rigid component that extends from the release assembly 730 and to the sensor probe 708. In the illustrated example, the structural board 771 includes a board elongated portion 774, a board blade portion 775, a board end portion 773, and a board aircraft portion 778. The PCBA component 770 having the structural board 771 may generally be shaped to fit to match the shape of the sensor probe 708 and/or the release assembly 730 defined by the superstructures 725a, 725b such that the PCBA component is arrangeable fully within the superstructure 725a, 725b. For example, the board elongated portion 774 may match a shape of the elongated tube 726 and fit therein. The board blade portion 775 may match a shape of the blade portion 734 at fit therein. The board end portion 773 may match a shape of the first and second seats 728a, 728 and fit therebetween. The board aircraft portion 778 may protrude from the board blade portion 734 for electrical interconnection with complementary electronic components of the aircraft. The PCBA component 770 may also include various other functions, including, but not limited to, being a control board that supports various electrical components of the aircraft.

The PCBA component 770 may include one or more printed circuit boards and/or integrated circuit components. For example, and as shown in the assembled configuration of FIG. 7, the PCBA component 770 may be fitted inside the sensor probe 708 and the release assembly 730. In the assembled configuration, the board aircraft portion 778 may be advanced into the electronics passage 736 of the mounting plate portion 732. The board aircraft portion 778 may protrude slightly from the mounting plate portion 732 such that the board aircraft portion 778 is engageable with complementary electronics of an aircraft.

In order to support vibration isolation, a dampener 760 is provided. The dampener 760 may be configured to sit on the mounting plate portion 732. The dampener 760 may include a dampener opening 762. In the assembled configuration, the board aircraft portion may be arranged extending through the dampener opening 762. The dampener 760 may further include notches 764. The notches 764 may define indents in the dampener material that are configured to receive a respective one of the prongs 752a-752d.

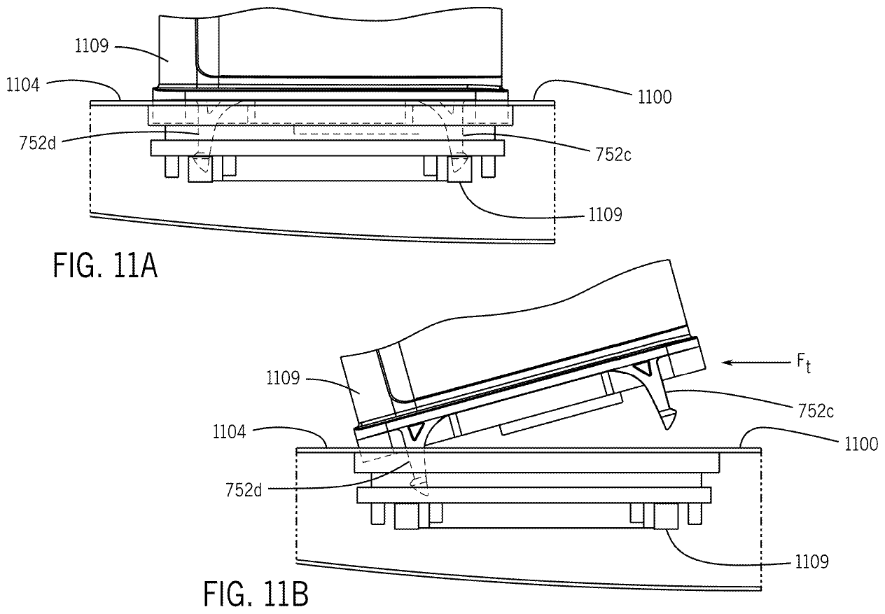

In operation, the release assembly 730 is releasably coupleable to a portion 1304 of an aircraft 1300, as shown in FIGS. 11A and 11B. The portion 1304 may be a wing assembly of the aircraft 1300, such as any of the wing assemblies described herein. The portion 1304 may include an opening 1306 that extends into a hollow body of the portion 1304. The portion 1304 may further include a catch 1308 arranged in the hollow body. The catch 1308 may include one or more catch seats 1309. The release assembly 730 may be releasably coupleable with the portion 1304 by advancing the prongs 752a-752d into the opening 1306. The prong 752a-752d may be advanced into the opening and seated in respective ones of the catch seats 1309. The catch seats 1309 may include a complementary geometry to the overhang features of the respective prongs 752a-752d. This may allow the overhang features to snap into place and define a snap fit with the catch seats 1309.

With reference to FIG. 11B, the release assembly 730 is shown partially separated from the portion 1304. For example, the release assembly 730 may receive a threshold force Fₜ. The threshold force Fₜ may be a force that results from the sensor probe 708 striking an object, as one example. When the threshold force Ft is a predetermined threshold force, the prongs 752a-752d may flex, as described herein. The flexing of the prongs 752a-752d may cause the connecting feature to be released from the catch 1308. For example, the flexing of the prongs 752a-95d may cause the respective ones of the overhang portions of the prongs to unseat from the catch seats 1309. Such flexing may, in turn, permit the release assembly to separate from the portion of the aircraft.

In the example of FIG. 8A, and with particular reference to FIG. 8B, the sensor probe 708 may include a second portion 780 analogous to the second portion 230 described herein. The nosecone 710 may define an acoustic pathway 790 along which audio signals may travel from the environment external to the aircraft to the microphone component assembly 776. Similar to the second portion 230, the second portion 780 may be formed from a generally acoustically transparent material, such as the various porous materials and the like described herein. The second portion 780 may be formed of a wall that may be a section of the porous material revolved about an axial direction of the nosecone 710. The nosecone 710 may include a tapered portion 782 receivable in the internal volume 234 formed by the second portion 780. The tapered portion 782 may help to direct or smooth the flow of the audio signal 192 or air toward the microphone component assembly 776. In other embodiments, the tapered portion 782 is not included.

The PCBA component 770 includes a microphone component assembly 776 which may be disposed at the board end portion 773. The PCBA component 770 may include a circuit board component 772 at the board blade portion 775. The board end portion 773 may be arranged such that the microphone component assembly 776 is positioned adjacent or partially within the through portion 727 of the nosecone mount 720. The through portion 727 may include an aperture 784 at a terminal end thereof that provides fluid and/or acoustic communication between the internal volume 234 and the board end portion 773 and/or circuit board component 772. For example, each of the first and second elongated tube portions 724a/b may form a portion (e.g., half) of the aperture 784, such that when assembled, the elongated tube portions 724a/b together form the aperture 784. A conduit 786 may be formed in a tip of the 724a and/or 724b. The conduit 786 may be in fluid and/or acoustic communication with the internal volume 234, such as via the aperture 784. The PCBA component 770 may have an aperture 788 formed therethrough (e.g., at the board end portion 773) that enables fluid and/or acoustic communication between the conduit 786 and the microphone component assembly 776. For example, the aperture 788 may be a through aperture that passes from one side of the PCBA component 770 to the other side of the PCBA component 770. The microphone component assembly 776 may be disposed adjacent to an end of the aperture 788.

In this regard, the microphone component assembly 776 may be configured to detect acoustic signal received through the nosecone 710, such as where the internal volume 234 of the nosecone 710 is in acoustic or fluidic communication with the through portion 727 and a portion (e.g., the second portion) of the nosecone 710 is constructed from an acoustically transparent material, as described herein. Thus, the audio signal 192 may pass along the acoustic pathway 790 from the environment outside the nosecone, through the second portion 780, into the internal volume 234, through the aperture 784, into the conduit 786, through the aperture 788, and to the microphone component assembly 776.

The PCBA component 770 may include an electrical coupling between the microphone component assembly 776 and the circuit board component 772. The circuit board component 772 may include one or more processing units that process a signal obtained by the microphone component assembly 776. The circuit board component 772 may be electrically coupleable with the aircraft via the board aircraft portion 778.

Benefits or advantages of the sensor probe 708 may include easier (e.g. tool-less) installation onto the aircraft, such as via the connecting feature 752 which can “click” into place on the aircraft. Manufacturing costs of the probe 708 may be reduced as well, via the use of parts compatible with high-volume manufacturing techniques (e.g., injection molded parts such as the first and second superstructures 725a/b) and/or the PCBA component 770. The nosecone 710 may have the benefit of being installable via simple twist-locking of the nosecone 710 to the nosecone mount 720. Thus, the nosecone 710 may be easily installed when the probe is assembled, and/or replaced due to damage, wear, replacement with a nosecone 710 having different aerodynamic or acoustical properties, etc. The probe 708 may also have a reduced cost and/or improved reliability due to a lower part count, (e.g., fewer electrical connectors and electrical connections from the use of the PBCA component 770 instead of discrete wires, connectors, sensors, etc.).

Other examples and implementations are within the scope and spirit of the disclosure and appended claims. Thus, the foregoing descriptions of the specific examples described herein are presented for purposes of illustration and description. They are not targeted to be exhaustive or to limit the examples to the precise forms disclosed. It will be apparent to one of ordinary skill in the art that many modifications and variations are possible in view of the above teachings.

1. A nosecone of an aircraft sensor probe, comprising:
a first portion defining a tip of the nosecone and formed from a first material;
a second portion aft of the first portion formed from a second material and defining an internal volume, the second material having a greater porosity than the first material; and
a third portion aft of the second portion and configured to arrange a microphone assembly relative to the internal volume.

2. The nosecone of claim 1, wherein the second material comprises a porous material configured to attenuate an audio signal received by the second portion and maintain an acoustic pathway into the internal volume.

3. The nosecone of claim 2, wherein the porous material is configured to maintain the acoustic pathway into the internal volume for signals having a frequency of less than about 1200 Hz.

4. The nosecone of claim 2, wherein the internal volume is configured to direct the audio signal toward the microphone assembly.

5. The nosecone of claim 2, wherein the porous material comprises a plurality of particles at least partially fused to one another and defining a plurality of pores therebetween.

6. (canceled)

7. (canceled)

8. The nosecone of claim 1, wherein the second portion comprises a tubular wall of a porous material revolved about an axis of the nosecone to define the internal volume.

9. (canceled)

10. The nosecone of claim 1, wherein the second material comprises a porous material including a sintered polymer material.

11. The nosecone of claim 10, wherein the sintered polymer material comprises one or more of a polyethylene material or a sintered polypropylene material.

12. (canceled)

13. The nosecone of claim 1, wherein one or both of the first portion or the third portion defines a mounting structure configured to engage the second portion.

14. The nosecone of claim 13, wherein the mounting structure includes a nosecone mount with a locking groove that rotationally receives the nosecone.

15. The nosecone of claim 14, wherein the nosecone is securable to the nosecone mount via a binary mount structure.

16. The nosecone of claim 13, wherein the mounting structure comprises one or more prongs extending into a thickness of the second portion.

17. The nosecone of claim 14, wherein the nosecone mount includes a first aperture formed therein and in fluid or acoustic communication with the internal volume.

18. The nosecone of claim 17, wherein the mounting structure forms a conduit in fluid or acoustic communication with the internal volume and the first aperture.

19. (canceled)

20. The nosecone of claim 18, wherein the microphone assembly is arranged relative to the internal volume by a printed circuit board and the printed circuit board has a second aperture formed therein and in fluid or acoustic communication with the conduit, such that the microphone assembly is in fluid or acoustic communication with the internal volume via the first aperture, the second aperture, and the conduit.

21. The nosecone of claim 13, wherein the third portion is configured to structurally support and enhance a rigidity of the first portion and the second portion and is configured to define an interface and engage with a nosecone mount of the aircraft sensor probe.

22. (canceled)

23. The nosecone of claim 1, wherein the first portion, the second portion, and the third portion cooperate to define a continuous exterior contour of the nosecone.

24. A sensor probe for association with a portion of an aircraft the sensor probe comprising:
a nosecone; and
a microphone assembly within the nosecone and having a portion configured to receive an audio signal associated with an airflow downstream from a tip of the nosecone;
wherein the nosecone is configured to redirect the audio signals at the tip and reduce turbulent noise of the audio signal associated with non-parallel local flow angles of the airflow.

25. The sensor probe of claim 24, wherein a tip of the nosecone is formed from an air-impervious plastic material comprising a nylon material or a polycarbonate material and wherein the nosecone comprises a porous material downstream of the tip configured to maintain an acoustic pathway for the audio signal between the portion of the microphone assembly and an external environmental of the sensor probe.

26. (canceled)

27. The sensor probe of claim 26, wherein the porous material is configured to attenuate the audio signal and maintain the acoustic pathway for signals having a frequency of less than about 1200 Hz.

28. The sensor probe of claim 27, wherein the porous material is arranged to define one or more discrete sections of the nosecone downstream of the tip and wherein the porous material defines an internal volume and the microphone assembly is mounted facing the internal volume.

29. (canceled)

30. The sensor probe of claim 24, wherein:
the nosecone defines an acoustic pathway to a portion of the microphone assembly;
the nosecone is selectively securable to the sensor probe by a nosecone mount; and
the acoustic pathway is formed, in part, by a first aperture formed in the nosecone mount and in fluid or acoustic communication with an internal volume.

31. The sensor probe of claim 30, wherein the acoustic pathway is formed, in part, by a mounting structure forms a conduit in fluid or acoustic communication with the internal volume and the first aperture.

32. The sensor probe of claim 31, wherein the microphone assembly arranged relative to the internal volume by a printed circuit board and wherein the printed circuit board has a second aperture formed therein and in fluid or acoustic communication with the conduit, such that the microphone assembly is in fluid or acoustic communication with the internal volume via the first aperture, the second aperture, and the conduit.

33. (canceled)

34. The sensor probe of claim 29, wherein the portion of the microphone assembly is arranged facing a direction transverse to an axial direction of the internal volume.

35. The sensor probe of claim 29, further comprising a sealing element configured to block moisture intrusion towards the microphone assembly.

36. The sensor probe of claim 24, wherein the nosecone defines an acoustic pathway to the portion of the microphone assembly through a cylindrical segment of the nosecone, wherein the cylindrical segment is a radially symmetric tube formed from a porous sintered material.

37.-46. (canceled)
